(19) United States
(12) Patent Application Publication
(10) Pub. No.: US 2008/0033861 A1
(43) Pub. Date: Feb. 7, 2008

(54) Sale Price Determination Method and System Using Cumulative Distributions on Internet

(76) Inventor: Min-Cheol Jeon, Yangju (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/594,321

(22) PCT Filed: Mar. 23, 2005
(86) PCT No.: PCT/KR05/00812

§ 371 Date: Jan. 3, 2007

(30) Foreign Application Priority Data
Mar. 27, 2004 (KR) 10-2004-0021017

(51) Int. Cl. G06Q 40/00

(52) U.S. Cl. 705/37

(57) ABSTRACT

Disclosed herein is a mutual agreement type sale price determination method using cumulative distributions. The sale price determination method includes the steps of storing offered selling prices, desired quantities of commodities to sell, and personal information from the sellers, and offered purchasing prices, desired quantities of commodities to purchase, and personal information from the purchasers; obtaining cumulative distributions of the desired quantities of commodities to sell by arranging the offered selling prices and the desired quantities of commodities to sell in order ranging from a lowest price to a highest price; obtaining cumulative distributions of the desired quantities of commodities to purchase by arranging the offered purchasing prices and the desired quantities of commodities to purchase in order ranging from the highest price to the lowest price; and determining a sale price and the quantities of commodities for sale based on the cumulative distributions of the desired quantities of commodities to sell and purchase.

### TECHNICAL FIELD

The present invention relates, in general, to a mutual agreement type sale price determination method and system, in which a plurality of purchasers and a plurality of sellers determine at least one sale price to trade commodities using an on-line auction method and, more particularly, to a method and system for determining a mutual-agreement-upon sale price and the quantity of commodities for sale by obtaining the cumulative distributions of offered selling prices and offered purchasing prices and comparing the cumulative distributions with each other based on the quantity of commodities for sale and a cumulative deviation.

### BACKGROUND ART

Currently, home shopping, a form of purchasing and selling products using electronic (e)-commerce, is attracting much attention, and electronic auctions also are the focus of great interest. Price determination and sales methods in e-commerce that is conducted on the Internet are classified into a fixed price method, which shopping sites adopt, and an auction method, which auction sites adopt.

The fixed price method adopted by shopping sites is a passive sales method in which suppliers unilaterally determine prices and consumers determine whether given prices are acceptable, so that it is difficult for the fixed price method to meet the desire of the consumers who want to actively negotiate prices.

Meanwhile, cyber auctions conducted in auction sites are generally classified into a usual auction in which sale is achieved when an auction is accomplished in such a way that a seller and a plurality of purchasers participate in the auction via the Internet, the seller publishes sales conditions and the plurality of purchasers tender bids, and a reverse auction in which sale is achieved when an auction is accomplished in such a way that a purchaser publishes sales conditions, and a plurality of sellers tender bids.

However, the usual auction and the reverse auction are seller-centered and purchaser-centered sales methods, in which the seller side and the purchaser side do not both compete in themselves, that is, only one side competes internally and the other side accepts the price when auction finishes, so that unwanted results may occur. Furthermore, since the price determination of the sellers and the purchasers varies with the competition conditions of auction participants until a successful bid is achieved, a problem occurs in that the variation of the final bid price is great.

Accordingly, the auction market is limited because it is difficult to encourage the participation either of sellers who desire to quickly sell a large quantity of commodities or purchasers who desire to quickly purchase a large quantity of commodities, and because auction prices are determined in more unfavorable conditions than those of wanted prices.

### DISCLOSURE OF INVENTION

### Technical Problem

Accordingly, the present invention has been made keeping in mind the above problems occurring in the prior art, and an object of the present invention is to provide a sale price determination method and system, which allow a reasonable sale price to be determined, thus inducing sellers and purchasers to offer mutually competitive prices and increasing the possibility of sale. Furthermore, another object of the present invention is to provide a sale price determination method and system that allows transactions to be made at prices better than prices offered by both sellers and purchasers, through the active participation of the sellers and the purchasers.

### Technical Solution

In order to accomplish the above object, the present invention provides a mutual agreement type sale price determination method using cumulative distributions, in which a plurality of purchasers and a plurality of sellers determine a sale price to trade commodities using an on-line auction method, including the first step of receiving offered selling prices, the desired quantities of commodities to sell, and personal information from the sellers, and offered purchasing prices, the desired quantities of commodities to purchase, and personal information from the purchasers through an input unit, and storing them in a storage unit; the second step of a price determination unit obtaining the cumulative distributions of the desired quantities of commodities to sell by arranging the offered selling prices and the desired quantities of commodities to sell, which are input from the sellers, in order ranging from the lowest price to the highest price with respect to a reference price; the third step of a price determination unit obtaining the cumulative distributions of the desired quantities of commodities to purchase by arranging the offered purchasing prices and the desired quantities of commodities to purchase, which are input from the purchasers, in order ranging from the highest price to the lowest price with respect to the reference price; the fourth step of the price determination unit arranging the cumulative distributions of the desired quantities of commodities to sell and the cumulative distributions of the desired quantities of commodities to purchase according to individual prices between the lowest and highest prices with respect to the reference price, and comparing the cumulative distributions with each other; and the fifth step of the price determination unit determining at least one price, at which, in the cumulative distributions of the desired quantities of commodities to sell and purchase, a quantity of commodities for sale is maximal and a cumulative deviation is minimal, to be the sale price, and determining the quantity of commodities, which is available for sale at the determined sale price, to be a quantity of commodities for sale.

In addition, in order to accomplish the above object, the present invention provides a mutual agreement type sale price determination system using cumulative distributions, in which a plurality of purchasers and a plurality of sellers determine a sale price to trade commodities using an on-line auction method, including an input unit for receiving offered selling prices, the desired quantities of commodities to sell, and personal information from the sellers, and offered purchasing prices, the desired quantities of commodities to purchase, and personal information from the purchasers; a storage unit for storing the offered selling prices, the desired quantities of commodities to sell, and the personal information input from the sellers, and the offered purchasing prices, the desired quantities of commodities to purchase, and the personal information input from the purchasers; a display unit for displaying information on commodities that the sellers and purchasers want to trade, and an input window so that information on sales is input therethrough; and a price determination unit for obtaining the cumulative distributions of the desired quantities of commodities to sell by arranging the offered selling prices and the desired quantities of commodities to sell, which are input from the sellers, in order ranging from the lowest price to the highest price with respect to a reference price, and obtaining the cumulative distributions of the desired quantities of commodities to purchase by arranging the offered purchasing prices and the desired quantities of commodities to purchase, which are input from the purchasers, in order ranging from the highest price to the lowest price with respect to the reference price, and determining at least one price, at which, in the compared cumulative distributions, the quantity of commodities for sale is maximal and a cumulative deviation is minimal, to be the sale price, and determining a quantity of commodities available for sale at the sale price to be a quantity of commodities for sale by arranging the cumulative distributions of the desired quantities of commodities to sell and the cumulative distributions of the desired quantities of commodities to purchase and comparing the cumulative distributions with each other according to prices arranged on the basis of the reference price.

Purchasers in the present invention are limited to entrepreneurs who are actual consumers or distributors recognized by a related business field, and who directly receive a bill of sale and possess cash settlement capability. In contrast, sellers are limited to entrepreneurs who are person possessing raw material, commodities and inventory or distributors recognized by a related business field, and directly publishes a bill of sale and possesses the capability to sincerely fulfill contracts of delivery.

Commodity items traded in the present invention are items for which persons in the related business field are commonly recognized, and which are discriminated and classified according to trade names and chief characteristics, then are registered as standardized items, and are traded. For the standardized items, reference prices are offered in consideration of international prices, exchange rates and sale patterns.

Furthermore, the highest and lowest prices that can be offered by sellers and purchasers are predetermined. The highest price and the lowest prices are determined according to fixed ratios on the basis of reference prices. The sellers and purchasers cannot cancel sales conditions offered to the sale determination system of the present invention. The sales conditions are valid only on a corresponding day and automatically become invalid if a sale is not achieved on that day.

Furthermore, in the present invention, it is assumed that the quantities of desired commodities to sell and the quantities of desired commodities to purchase, which are offered by sellers and purchasers, are set on a minimal unit basis, and sales are conducted on the minimal unit. The sales conducted in the present invention can be applied to the sales of the day, and the sales of the day are terminated within a reference time. The sale prices and the quantities of commodities for sale are determined based on offered conditions input within the reference time period, and notices of the sale price and the quantities of commodities for sale are given to the sellers and purchasers.

### Advantageous Effects

The present invention provides a method and system for determining a mutual agreement type price and the quantity of commodities for sale by obtaining the cumulative distributions of input offered selling prices and input offered purchasing prices and comparing the cumulative distributions based on the quantity of commodities for sale and a cumulative deviation, thus being capable of offering reasonable sale prices, so that it can induce sellers and purchase to offer competitive prices. Furthermore, both the sellers and purchasers can trade commodities at optimal prices. Furthermore, prompt sale can be accomplished at inexpensive prices and in large quantities.

### DESCRIPTION OF DRAWINGS

The above and other objects, features and advantages of the present invention will be more clearly understood from the following detailed description taken in conjunction with the accompanying drawings, in which:

FIG. 1 is a schematic block diagram showing the construction of a sale price determination system according to the present invention;

FIG. 2 is a flowchart showing a sale price determination method using cumulative distributions according to the present invention;

FIG. 3 is a diagram illustrating a sale price determination method using cumulative distributions according to a first embodiment of the present invention;

FIG. 4 is a diagram illustrating a sale price determination method using cumulative distributions according to a second embodiment of the present invention;

FIG. 5 is a diagram illustrating a sale price determination method using cumulative distributions according to a third embodiment of the present invention; and

FIG. 6 is a diagram illustrating a sale price determination method using cumulative distributions according to a fourth embodiment of the present invention.

### BEST MODE

Embodiments of the present invention are described in detail with reference to the accompanying drawings below.

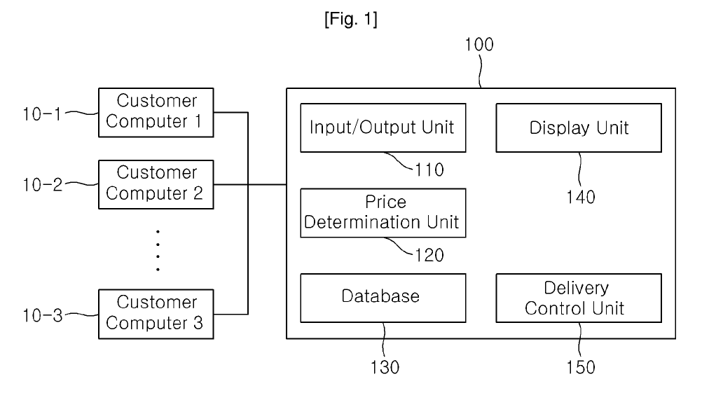

FIG. 1 is a schematic block diagram showing the construction of a sale price determination system, which performs a mutual agreement type sale price determination method on the Internet, according to the present invention.

In FIG. 1, reference numerals 10-1 to 10-n indicate a plurality of sellers' or purchasers' computer terminals, which are connected to a sale price determination system 100 via the Internet.

Furthermore, the sale price determination system 100 includes an input/output unit 110, a price determination unit 120, a database 130, a display unit 140 and a delivery control unit 150.

Offered selling prices, the desired quantities of commodities to sell, offered purchasing prices and the desired quantities of commodities to purchase, which are input through the plurality of sellers' or purchasers' computer terminals, are input to the input/output unit 110 of the sale price determination system 100, and information on the offered selling prices, the desired quantities of commodities to sell, the offered purchasing prices, the desired quantities of commodities to purchase, and personal information (trade names, entrepreneurs, representatives, present addresses, business types, items, persons in charge, telephone numbers, e-mail addresses, mobile phone numbers, persons in charge of sale, authentication numbers and passwords) on the sellers and the purchasers are stored in the database 130.

The display unit 140 displays information on commodities to be traded, the reference prices of the commodities, and the highest and lowest prices capable of being offered. Furthermore, the display unit 140 displays an input window in which the sellers and purchasers can enter sales conditions.

The price determination unit 120 obtains the cumulative distributions of the desired quantities of commodities to sell in order ranging from the lowest price to the highest price with respect to the offered selling prices that are input from the sellers, obtains the cumulative distributions of the desired quantities of commodities to purchase in order ranging from the highest price to the lowest price with respect to the offered purchasing prices that are input from the purchaser, arranges the cumulative distributions of the desired quantities of commodities to sell and the cumulative distributions of the desired quantities of commodities to purchase in price order and then compares the cumulative distributions with each other, determines a price, at which, in the cumulative distributions of the desired quantities of commodities to sell and the desired quantities of commodities to purchase that are compared with each other, the quantity of commodities for sale is maximal and an cumulative deviation is minimal, to be at least one sale price, and determines the quantities of commodities, which is available for sale at the sale price, to be the quantity of commodities for sale.

In the case in which the number of determined sale prices is two, the cumulative quantities of commodities to purchase and the cumulative quantities of commodities to sell are compared with each other, so that a higher price is determined to be the sale price in the case in which the cumulative quantity of commodities to purchase is larger than the cumulative quantities of commodities to sell, and a lower price is determined to be the sale price in the case in which the cumulative quantity of commodities to sell is larger than cumulative quantity of commodities to purchase. Furthermore, in the case in which the cumulative quantity of commodities to purchase and the cumulative quantity of commodities to sell in the two determined sale prices are the same as each other or the cumulative quantities of commodities to purchase and the cumulative quantities of commodities to sell are symmetrically crossed, determining an average value of the two determined sale prices to be a sale price may also be one method.

In the case in which the number of determined sale prices is three or four, the cumulative quantities of commodities to purchase and the cumulative quantities of commodities to sell at the determined sale prices are compared with one another, so that an average value of a higher price, at which the cumulative quantity of commodities to purchase is larger, and a lower price, at which the cumulative quantity of commodities to sell is larger, is determined to be the sale price.

When the sale price and the quantity of commodities for sale are determined, the delivery control unit 150 reads personal information on the seller and the purchaser who have made a deal from the database, classifies the personal information according to an area, sale characteristics, and the degree of preference, and determines a sale type so that a seller and a purchaser offering optimal conditions can make a deal with each other. Accordingly, the delivery control unit 150 notifies both the seller and the purchaser of the determined sale type through the input/output unit 110.

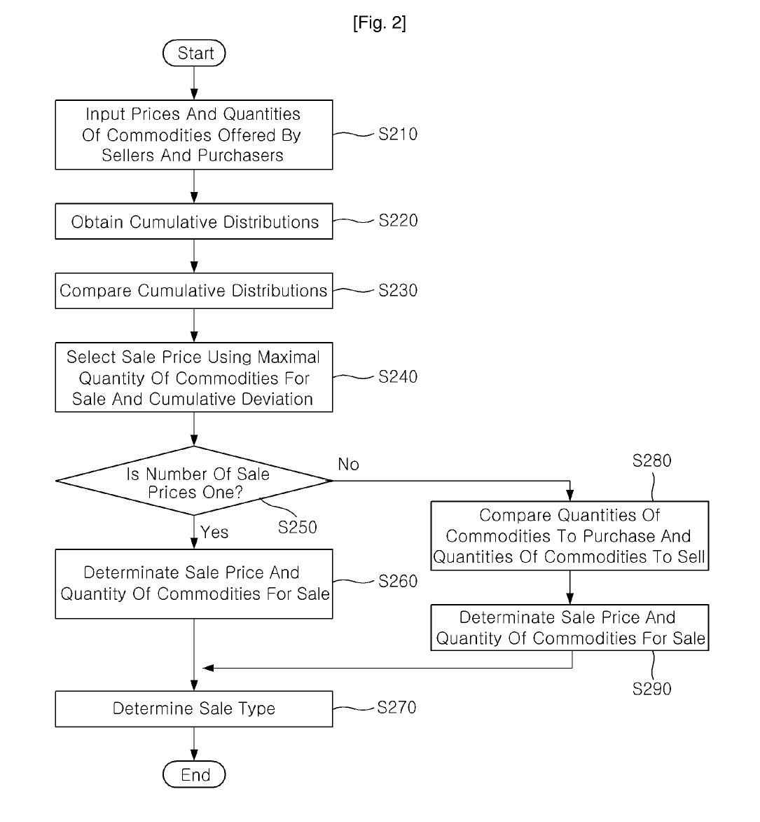

FIG. 2 is a flowchart showing a sale price determination method using cumulative distributions according to the present invention.

At step S210, sellers check the inventories of commodities that they want to sell, and make lists of commodities available for sale. Thereafter, the sellers check the reference prices of the sale price determination system 100, determine desired selling unit prices of commodities with reference to the highest prices and the lowest prices that are offered by the sale price determination system 100, and input offered selling prices and the desired quantities of commodities to sell through the sellers' computer terminals. The offered selling prices and the desired quantities of commodities to sell are input from the sellers' computer terminals to the input/output unit 110 of the sale price determination system 100.

Furthermore, the purchasers make specifications of required commodities, check the reference prices of the sale price determination system, determine desired purchasing unit prices with reference to the highest and lowest prices that are offered by the sale price determination system 100, and input offered purchasing prices and the desired quantities of commodities to purchase through the purchasers' computer terminals. The offered purchasing prices and the desired quantities of commodities to purchase are input from the purchase' computer terminals to the input/output unit 110 of the sale price determination system 100.

At step S220, the price determination unit 120 of the sale price determination system 100 arranges the offered selling prices and the desired quantities of commodities to sell, which are input by the sellers, in order ranging from the lowest prices to the highest prices, the lowest and highest prices being predetermined according to a fixed ratio with respect to the reference prices, and obtains a cumulative distributions of the desired quantities of commodities to sell. In contrast, the price determination unit 120 of the sale price determination system 100 arranges the offered purchasing prices and the desired quantities of commodities to purchase, which are input by the purchasers, in order ranging from the lowest prices to the highest prices, the lowest and highest prices being predetermined according to a fixed ratio with respect to the reference prices, and obtains cumulative distributions of the desired quantities of commodities to purchase. In this case, the cumulative distributions of the quantities of commodities to purchase are obtained in order ranging from the highest prices to the lowest prices, and the cumulative distributions of the quantities of commodities for sale are obtained in order ranging from the lowest prices to the highest prices.

At step S230, the obtained cumulative distributions are arranged based on the lowest and highest prices predetermined according to the fixed ratio with respect to the reference prices, and the cumulative distributions of the desired quantities of commodities to sell and the desired quantities of commodities to purchase are compared with each other, and the quantities of commodities for sale and the cumulative deviation at which sale can be accomplished are calculated.

In this case, at step S240, a price, at which the quantity of commodities for sale is maximal, is determined to be the sale price. Furthermore, in the case in which the number of determined sale prices is two or more, a price, at which the minimum cumulative deviation of which is minimal, is determined to be the sale price.

At steps S280 and S290, although a price, the cumulative deviation of which is minimal, is determined to be the sale price, the case that the sale price determined as described above is two may occur. In this case, the cumulative quantity of commodities to purchase and the cumulative quantity of commodities to sell in the two sale prices are compared with each other, the high one of the two sale prices is determined to be the sale price in the case in which the cumulative quantity of commodities to purchase excesses the cumulative quantity of commodities to sell, that is, in the case in which the cumulative quantity of commodities to purchase is larger than the cumulative quantity of commodities to sell. Similarly, the low one of the sale prices is determined to be the sale price in the case in which the quantity of commodities to sell excesses the quantity of commodities to purchase, that is, the cumulative quantity of commodity to purchase is smaller than the cumulative quantity of commodities to sell. However, the average value of the two sale prices is determined to be the sale price, in the case of no discrepancy between the cumulative quantities of commodities to sell and purchase, that is, in the case in which the cumulative quantity of commodities to purchase and the cumulative quantity of commodities to sell are the same. Furthermore, the average value of the two sale prices is also determined to be the sale price, in the case in which the cumulative quantities of commodities to purchase and the cumulative quantities of commodities to sell are symmetrically crossed.

In the case in which the number of determined sale prices is three or four, the cumulative quantities of commodities to purchase and the cumulative quantities of commodities to sell in the determined sale prices are compared with one another, so that the average value of a higher price, at which the cumulative quantity of commodities to purchase is larger, and a lower price, at which the cumulative quantity of commodities to sell is larger, is determined to be the sale price.

At step S270, when the sale price and the quantity of commodities to sell are determined in the price determination unit 120, the delivery control unit 150 reads the personal information on the sellers and purchasers, who have made a deal, from the database 130, classifies the personal information according to an area, sale characteristics, and the degree of preference, and determines a sale type so that a seller and a purchaser offering optimal sales conditions deal with each other. Accordingly, the delivery control unit 150 notifies both the seller and the purchaser of the sale type through the input/output unit 110 according to the determined sale type.

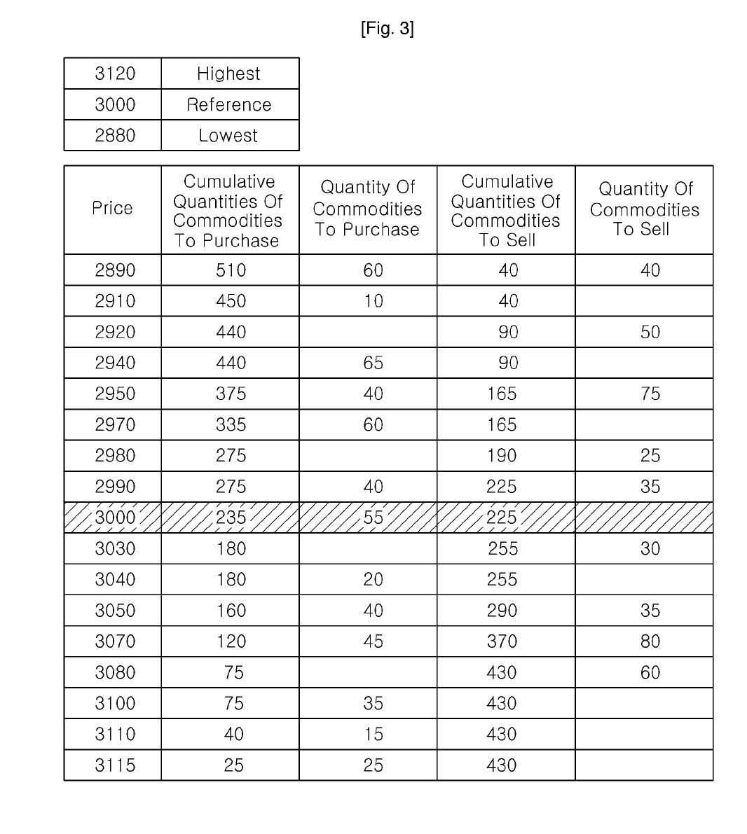

FIG. 3 is a diagram illustrating a sale price determination method using cumulative distributions according to a first embodiment of the present invention.

In the first embodiment, the reference price of commodities for sale is $3000, the highest price at the time of sale is $3120, and the lowest price at the time of sale is $2880.

The offered purchasing price, the desired quantities of commodities to purchase, the offered selling prices and the desired quantities of commodities to sell are arranged according to the lowest and highest prices, the cumulative distributions of the desired quantities of commodities to purchase are obtained in order ranging from the highest price to the lowest price, and the cumulative distributions of the desired quantities of commodities to sell are obtained in order ranging from the lowest price to the highest price. Accordingly, the cumulative distributions of the desired quantities of commodities to sell and the desired quantities of commodities to purchase are obtained as shown in FIG. 3.

When the obtained cumulative distributions are compared with one another, the quantities of commodities available for sale are obtained. That is, the quantity of commodities for sale is 225 at $2990, 225 at $3000, and 180 at $3030. Therefore, the maximal quantity of commodities for sale, which is 225, occurs at both a sale price of $2990 and a sale price of $3000. In this case, a cumulative deviation at $ 2990 is 275-225=50 and a cumulative deviation at $3000 is 235−225=10, so that $3000, the cumulative of which is small, is determined to be the sale price, and 255 is determined to be the quantity of commodities for sale.

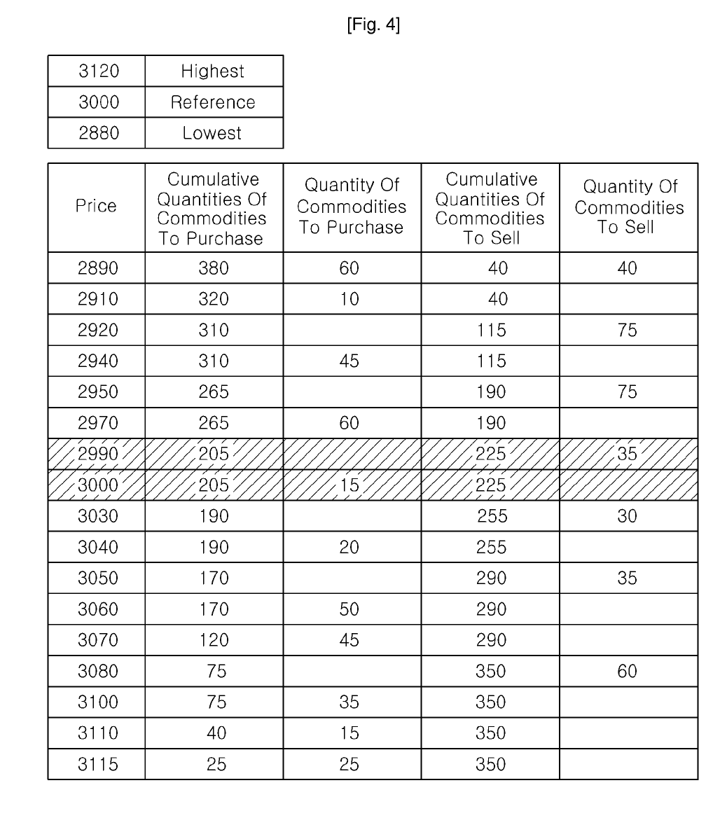

FIG. 4 is a diagram illustrating a sale price determination method using cumulative distributions according to a second embodiment of the present invention.

In the second embodiment, the reference price for commodities for sale is $3000, the highest price at the time of sale is $3120, and the lowest price at the time of sale is $2880.

In the same manner as in FIG. 3, the offered purchasing prices, the desired quantities of commodities to purchase, the offered selling prices and the desired quantities of commodities to sell, are arranged according to the lowest and highest prices, the cumulative distributions of the desired quantities of commodities to purchase are obtained in order ranging from the highest price to the lowest price, and the cumulative distributions of the desired quantities of commodities to sell are obtained in order ranging from the lowest price to the highest price.

In the same manner as in FIG. 3, when the obtained cumulative distributions are compared with one another, the quantity of commodities for sale is 205 at $2990, 205 at $3000, and 190 at $3030. Therefore, the maximum quantity of commodities for sale, which is 205, is generated at both a price of $2999 and a price of $3000. In this case, a cumulative deviation at $2990 is 225−205=20 and a cumulative deviation at $3000 is 225−205=20, so that two sale prices are determined.

In the above-described case, the cumulative quantity of commodities to purchase is smaller than the cumulative quantity of commodities to sell because, at $2990, the cumulative quantity of commodities to purchase is 205 and the cumulative quantity of commodities to sell is 225, so that the low price, $2990, is determined to be the sale price, and, as the result, 205 is determined to be the quantity of commodities for sale.

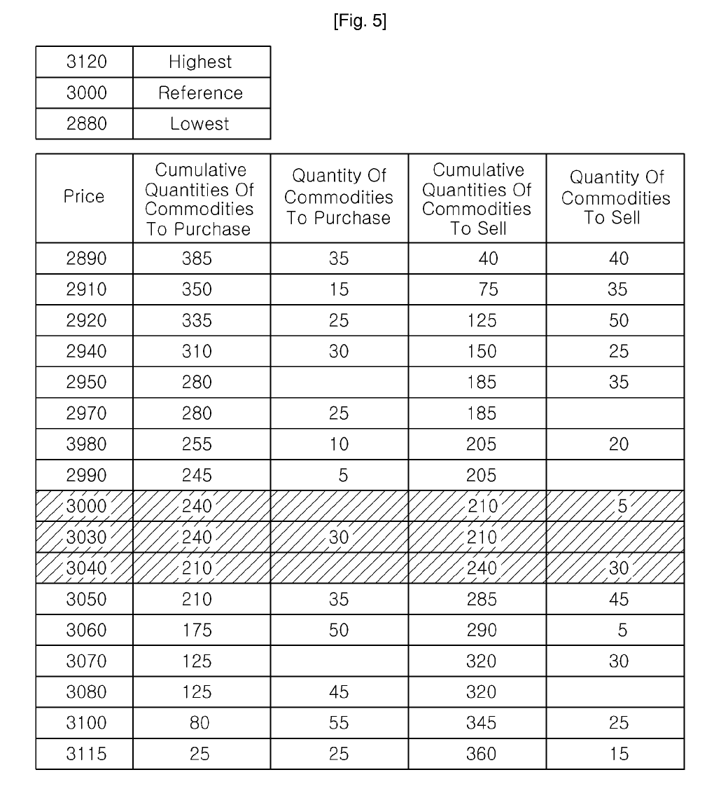

FIG. 5 is a diagram illustrating a sale price determination method using cumulative distributions according to a third embodiment of the present invention.

In the third embodiment, the reference price of commodities for sale is $3000, the highest price at the time of sale is $3120, and the lowest price at the time of sale is $2880.

In the same manner as in FIGS. 3 and 4, the offered purchasing prices, the desired quantities of commodities to purchase, the offered selling prices and the desired quantities of commodities to sell are arranged based on the lowest and highest prices, so that the cumulative distributions of the desired quantities of commodities to purchase are obtained in order ranging from the highest price to the lowest price, and the cumulative distributions of the desired quantities of commodities to sell are obtained in order ranging from the lowest price to the highest price.

In the same manner as in FIGS. 3 and 4, when the obtained cumulative distributions are compared with one another, the quantity of commodities for sale is 210 at $3000, 210 at $3030, and 210 at $3040 and $3050. Therefore, the maximum quantity of commodities for sale is 210 at all four sale prices. In this case, each of cumulative deviations at $3000, $3030 and $3040 is 240−210=30 and a cumulative deviation at $3050 is 285−210=75, so that, of the four sale prices, the cumulative deviation is minimal at $3000, $3030 and $3040 and, as a result, three sale prices are determined.

In the above-described case, the cumulative quantities of commodities to purchase and the cumulative quantities of commodities to sell at the three determined sale prices are compared with one another, so that the average of $3030 that is the highest price among the sale prices, that is, $3000 and $3030 at which the cumulative quantity of commodities to purchase is larger, and $3040 that is the sale price at which the cumulative quantity of commodities to sell is larger, that is, (3030+3040)/2=3035, is determined to be the sale price. In this case, 210 is determined to be the quantity of commodities for sale.

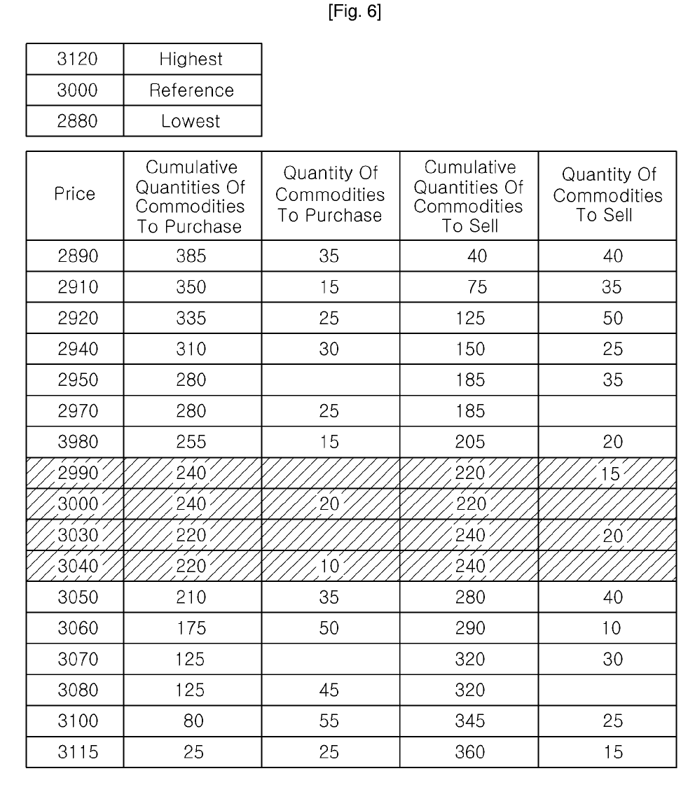

FIG. 6 is a diagram illustrating a sale price determination method using cumulative distributions according to a fourth embodiment of the present invention.

In the same manner as in FIGS. 3 to 5, when the obtained cumulative distributions are compared with one another, the quantity of commodities for sale is 220 at $2990, $3000, $3030 and $3040, the cumulative deviation for all the cases is 240−220=20 that is minimal and, as a result, four sale prices are determined.

In the above-described case, the cumulative quantities of commodities to purchase and the cumulative quantities of commodities to sell at the four determined sale prices are compared with one another as in FIG. 5, so that (3000+3030)/2=3015, which is an average of $3000 that is the highest price among the sale prices, that is, $2990 and $3000 at which the cumulative quantity of commodities to purchase is larger, and $3030 that is the lowest price among the sale prices, that is, $3030 and $3040 at which the cumulative quantity of commodities to sell is larger, is determined to be the sale price. In this case, 220 is determined to be the quantity of commodities for sale.

### INDUSTRIAL APPLICABILITY

As described above, the present invention provides a method and system for determining a mutual agreement type price and the quantity of commodities for sale by obtaining the cumulative distributions of input offered selling prices and input offered purchasing prices and comparing the cumulative distributions based on the quantity of commodities for sale and a cumulative deviation, thus being capable of offering reasonable sale prices, so that it can induce sellers and purchase to offer competitive prices. Furthermore, both the sellers and purchasers can trade commodities at optimal prices. Furthermore, prompt sale can be accomplished at inexpensive prices and in large quantities.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A mutual agreement type sale price determination method using cumulative distributions, in which a plurality of purchasers and a plurality of sellers determine a sale price to trade commodities using an on-line auction method, comprising:
a first step of receiving offered selling prices, desired quantities of commodities to sell, and personal information from the sellers, and offered purchasing prices, desired quantities of commodities to purchase, and personal information from the purchasers through an input unit, and storing them in a storage unit;
a second step of a price determination unit obtaining cumulative distributions of the desired quantities of commodities to sell by arranging the offered selling prices and the desired quantities of commodities to sell, which are input from the sellers, in order ranging from a lowest price to a highest price with respect to a reference price;
a third step of a price determination unit obtaining cumulative distributions of the desired quantities of commodities to purchase by arranging the offered purchasing prices and the desired quantities of commodities to purchase, which are input from the purchasers, in order ranging from the highest price to the lowest price with respect to the reference price;
a fourth step of the price determination unit arranging the cumulative distributions of the desired quantities of commodities to sell and the cumulative distributions of the desired quantities of commodities to purchase according to individual prices between the lowest and highest prices with respect to the reference price, and comparing the cumulative distributions with each other; and
a fifth step of the price determination unit determining at least one price, at which, in the cumulative distributions of the desired quantities of commodities to sell and purchase, a quantity of commodities for sale is maximal and a cumulative deviation is minimal, to be the sale price, and determining the quantity of commodities, which is available for sale at the determined sale price, to be a quantity of commodities for sale.

2. The mutual agreement type sale price determination method according to claim 1, further comprising, if the number of the determined sale prices is two, a sixth step of comparing cumulative quantities of commodities to purchase and cumulative quantities of commodities to sell at the determined sale prices, determining a higher price to be the sale price when a cumulative quantity of commodities to purchase is greater than a cumulative quantity of commodities to sell, and a lower price to be the sale price when a cumulative quantity of commodities to sell is greater than a cumulative quantity of commodities to purchase, and determining an average of two sale prices to be the sale price when a cumulative quantity of commodities to purchase and a cumulative quantity of commodities to sell are the same, or cumulative quantities of commodities to purchase and cumulative quantities of commodities to sell are symmetrically crossed.

3. The mutual agreement type sale price determination method according to claim 2, further comprising, if the number of the determined sale prices is three or four, a seventh step of comparing cumulative quantities of commodities to purchase and cumulative quantities of commodities to sell at the determined sale prices, and determining an average of a higher price, at which the cumulative quantity of commodities to purchase is greater than cumulative quantity of commodities to sell, and a lower price, at which the cumulative quantity of commodities to sell is greater than the cumulative quantity of commodities to purchase, to be the sale price.

4. The mutual agreement type sale price determination method according to claim 1, further comprising an eighth step of determining a sale type by determining the quantity of commodities for sale based on the determined sale price, and classifying the personal information according to an area, sale characteristics, and a degree of preference.

5. A mutual agreement type sale price determination system using cumulative distributions, in which a plurality of purchasers and a plurality of sellers determine a sale price to trade commodities using an on-line auction method, comprising:
an input unit for receiving offered selling prices, desired quantities of commodities to sell, and personal information from the sellers, and offered purchasing prices, desired quantities of commodities to purchase, and personal information from the purchasers;
a storage unit for storing the offered selling prices, the desired quantities of commodities to sell, and the personal information input from the sellers, and the offered purchasing prices, the desired quantities of commodities to purchase, and the personal information input from the purchasers;
a display unit for displaying information on commodities that the sellers and purchasers want to trade, and an input window so that information on sales is input therethrough; and
a price determination unit for obtaining cumulative distributions of the desired quantities of commodities to sell by arranging the offered selling prices and the desired quantities of commodities to sell, which are input from the sellers, in order ranging from a lowest price to a highest price with respect to a reference price, and obtaining cumulative distributions of the desired quantities of commodities to purchase by arranging the offered purchasing prices and the desired quantities of commodities to purchase, which are input from the purchasers, in order ranging from the highest price to the lowest price with respect to the reference price, and determining at least one price, at which, in the compared cumulative distributions, a quantity of commodities for sale is maximal and a cumulative deviation is minimal, to be the sale price, and determining a quantity of commodities available for sale at the sale price to be a quantity of commodities for sale by arranging the cumulative distributions of the desired quantities of commodities to sell and the cumulative distributions of the desired quantities of commodities to purchase and comparing the cumulative distributions with each other according to prices arranged on the basis of the reference price.

6. The mutual agreement type sale price determination system according to claim 5, wherein, if the number of the determined sale prices is two, the price determination unit compares cumulative quantities of commodities to purchase and cumulative quantities of commodities to sell at the determined sale prices, determines a higher price to be the sale price when a cumulative quantity of commodities to purchase is greater than a cumulative quantity of commodities to sell, and a lower price to be the sale price when a cumulative quantity of commodities to sell is greater than a cumulative quantity of commodities to purchase, and determines an average of two sale prices to be the sale price when a cumulative quantity of commodities to purchase and a cumulative quantity of commodities to sell are the same or when cumulative quantities of commodities to purchase and cumulative quantities of commodities to sell are symmetrically crossed and, if the number of the determined sale prices is three or four, the price determination unit compares the cumulative quantities of commodities to purchase and the cumulative quantities of commodities to sell at the determined sale prices, and determines an average of a higher price, at which a cumulative quantity of commodities to purchase is greater than a cumulative quantity of commodities to sell, and a lower price, at which a cumulative quantity of commodities to sell is greater than a cumulative quantity of commodities to purchase, to be the sale price.

7. The mutual agreement type sale price determination method according to claim 5, further comprising a delivery control unit for determining a sale type by determining the quantities of commodities for sale based on the determined sale price and classifying the personal information according to an area, sale characteristics, and a degree of preference.

8. The mutual agreement type sale price determination method according to claim 2, further comprising an eighth step of determining a sale type by determining the quantity of commodities for sale based on the determined sale price, and classifying the personal information according to an area, sale characteristics, and a degree of preference.

9. The mutual agreement type sale price determination method according to claim 3, further comprising an eighth step of determining a sale type by determining the quantity of commodities for sale based on the determined sale price, and classifying the personal information according to an area, sale characteristics, and a degree of preference.

10. The mutual agreement type sale price determination method according to claim 6, further comprising a delivery control unit for determining a sale type by determining the quantities of commodities for sale based on the determined sale price and classifying the personal information according to an area, sale characteristics, and a degree of preference.
